(19) United States
(12) Patent Application Publication
(10) Pub. No.: US 2024/0183821 A1
(43) Pub. Date: Jun. 6, 2024

(54) ULTRASONIC SENSOR SYSTEMS FOR CHARACTERIZING PARTICLE SUSPENSIONS

(71) Applicant: Sartorius Stedim Biotech GmbH, Göttingen (DE)

(72) Inventors: Samin Akbari, Winchester, MA (US); Robert Balke, Winchester, MA (US); Phillip Anderson, Belmont, MA (US); David James Pollard, Stow, MA (US); Amin Ganjian, Toronto (CA)

(73) Assignee: Sartorius Stedim Biotech GmbH, Göttingen (DE)

(21) Appl. No.: 18/285,587

(22) PCT Filed: Apr. 4, 2022
(86) PCT No.: PCT/IB2022/000190

§ 371 Date: Oct. 4, 2023

Related U.S. Application Data
(60) Provisional application No. 63/301,959, filed on Jan. 21, 2022.
(60) Provisional application No. 63/171,460, filed on Apr. 6, 2021.

(51) Int. Cl. G01N 29/036; G01N 15/00; G01N 15/02; G01N 15/06; G01N 29/34; G01N 29/44; G01N 29/46

(52) U.S. Cl. CPC G01N 29/036; G01N 15/02; G01N 15/06; G01N 29/34; G01N 29/4472; G01N 29/46; G01N 2015/0053; G01N 2015/0277; G01N 2015/0687; G01N 2291/02416; G01N 2291/02809; G01N 2291/02854

(57) ABSTRACT

Systems and methods for characterizing a plurality of particles suspended in a solution are described. In some embodiments, an ultrasonic interrogation signal may be emitted into a solution including a plurality of particles suspended in the solution. A resulting ultrasonic spectrum may be sensed and provided to a trained statistical model of the solution. The trained statistical model may then determine one or more properties of the plurality of particles.

### CROSS-REFERENCE TO RELATED APPLICATIONS

This application claims priority to U.S. Application Ser. No. 63/171,460, filed Apr. 6, 2021, and to U.S. Application Ser. No. 63/301,959, filed Jan. 21, 2022, the disclosures of each of which are incorporated herein by reference in their entirety.

### FIELD

Disclosed embodiments are related to ultrasonic sensor systems, and related methods, for characterizing particle suspensions in a solution.

### BACKGROUND

Ultrasonic sensors can be used to determine various parameters associated with suspensions in a solution. For example, static cell cultures in a bioreactor may be monitored using ultrasonic sensors.

### SUMMARY

In one embodiment, a method for characterizing a plurality of particles suspended in a solution includes: emitting an ultrasonic interrogation signal into the solution including the plurality of particles suspended in the solution; sensing a resulting ultrasonic spectrum; providing the ultrasonic spectrum to a trained statistical model of the solution; and determining one or more properties of the particles using the trained statistical model.

In one embodiment, a method for characterizing a plurality of particles suspended in a solution includes: obtaining an ultrasonic spectrum of the solution including the plurality of particles suspended in the solution; providing the ultrasonic spectrum to a trained statistical model of the solution; and determining one or more properties of the particles using the trained statistical model.

In another embodiment, an ultrasonic sensor system includes an ultrasonic transducer configured to emit an ultrasonic interrogation signal into a solution including a plurality of particles suspended in the solution. The ultrasonic transducer is configured to sense a resulting ultrasonic spectrum. The system also includes a processor operatively coupled to the ultrasonic transducer, where the processor is configured to receive the ultrasonic spectrum from the ultrasonic transducer. The processor is configured to perform the steps of: providing the ultrasonic spectrum to a trained statistical model of the solution; and determining one or more properties of the particles using the trained statistical model.

In yet another embodiment, a method for training a statistical model includes: obtaining training data, wherein the training data includes ultrasonic spectra for solutions including particles suspended in the solutions and one or more properties of the particles associated with the ultrasonic spectra; generating a trained statistical model using the training data; and storing the trained statistical model for subsequent use.

In another embodiment, a method for characterizing a plurality of particles suspended in a solution includes: obtaining an ultrasonic spectrum of the solution including the plurality of particles suspended in the solution; providing the ultrasonic spectrum to a first trained statistical model; determining a first property of the plurality of particles in the solution using the first trained statistical model; selecting a second trained statistical model based at least in part on the first property; providing the ultrasonic spectrum to the second trained statistical model; and determining a second property of the plurality of particles using the second trained statistical model.

In another embodiment, an ultrasonic sensor system includes an ultrasonic transducer configured to emit an ultrasonic interrogation signal into a solution including a plurality of particles suspended in the solution. The ultrasonic transducer is configured to sense a resulting ultrasonic spectrum. The system also includes a processor operatively coupled to the ultrasonic transducer. The processor is configured to receive the ultrasonic spectrum from the ultrasonic transducer, and the processor is configured to perform the steps of: providing the ultrasonic spectrum to a first trained statistical model; determining a first property of the plurality of particles in the solution using the first trained statistical model; selecting a second trained statistical model based at least in part on the first property; providing the ultrasonic spectrum to the second trained statistical model; and determining a second property of the plurality of particles using the second trained statistical model.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic diagram of one embodiment of a sensor system;

FIG. 2 is a schematic diagram of one embodiment of a sensor system;

FIG. 3 is a schematic perspective view of one embodiment of a well array;

FIG. 4A is a schematic cross-sectional diagram of a well array and transducer.

FIG. 4B is a schematic cross-sectional diagram of the transducer and well array of FIG. 4A in contact;

FIG. 5 is a schematic diagram of one embodiment of a method for training a statistical model;

FIG. 6. is a schematic diagram of one embodiment of a method for using a statistical model to determine properties of particles suspended in a solution;

FIG. 7 is a graph of a measured unprocessed ultrasonic spectrum including the interrogation pulse and subsequent response;

FIG. 8 is a Fourier transform of a measured ultrasonic spectrum;

FIG. 9 is a graph of Fourier transformed ultrasonic spectra illustrating Doppler frequency shift for different size particles without stirring;

FIG. 10 is a graph of Fourier transformed ultrasonic spectra for 10 μm particles suspended in solutions with different concentrations while being stirred at 500 RPM;

FIG. 11 is a graph of the measured Doppler shift for particles with different sizes;

FIG. 12 is a graph of the integrated power versus particle concentration;

FIG. 13 depicts transformed spectra for different size particles;

FIG. 14 is a multivariant graph of different size particles with different concentrations;

FIG. 15 depicts Fourier transformed ultrasonic spectra of suspensions including CHO cells in different concentrations;

FIG. 16 depicts data used to train a multivariant model;

FIG. 17 depicts a multivariant model versus measured verification data;

FIG. 18 is a plot of the measured amplitude and frequency for different concentrations of Chinese hamster ovary (CHO) cells;

FIG. 19 is a plot of the measured amplitude and frequency for different stirring speeds of the CHO cells;

FIG. 20 is a plot of the predicted versus actual CHO cell concentrations using the trained model;

FIG. 21 is a plot of the measured amplitude and frequency for different concentrations of nanoparticles;

FIG. 22 is a plot of the measured amplitude and frequency for different stirring speeds of the nanoparticles;

FIG. 23 is a plot of the predicted versus actual nanoparticle concentrations using the trained model; and

FIG. 24 is a plot of the predicted versus actual cell viability using a trained model.

### DETAILED DESCRIPTION

Ultrasonic sensors may be used to identify the size and concentration of various particles suspended in a solution using a Doppler frequency shift and/or integrated power observed in the measured ultrasonic spectra of a static solution. However, most practical processes do not involve static solutions. For example, cells included in a bioreactor are typically stirred or otherwise agitated to maintain the cells dispersed in solution and/or to provide a uniform dispersion of other components or materials in solution. The Inventors have recognized that this agitation or mixing of a solution complicates the use of ultrasonic sensors for characterizing cells or other particles dispersed in the solution due to the differences in Doppler frequency shift, integrated power, and/or other metrics becoming less apparent with increasing amounts of agitation. Additionally, for many applications it may be undesirable to interrupt a process in order to perform an ultrasonic measurement on a quiescent solution without mixing. Accordingly, the Inventors have recognized the benefits associated with ultrasonic sensors that are configured to characterize one or more properties of a solution including particles suspended therein even if the solution is monitored when the solution is being mixed or otherwise agitated.

In view of the above, the Inventors have recognized the benefits associated with using a trained statistical model for determining one or more properties of particles suspended within a solution using an ultrasonic transducer. In some instances, this trained statistical model may be capable of determining the one or more properties of the particles suspended within the solution as the solution is being agitated. For example, in one embodiment, a method for characterizing a plurality of particles suspended within a solution may include obtaining an ultrasonic signal as elaborated on further below. In one such embodiment, this may include emitting an ultrasonic interrogation signal into the solution. The ultrasonic interrogation signal may be subsequently backscattered from the plurality of particles and reflected by other structures such as an opposing wall of the system. The resulting ultrasonic spectrum may then be sensed and provided as an input to a trained statistical model. Regardless of the specific model used, the trained statistical model may be used to determine one or more properties of the particles that may be output for subsequent use and/or storage. Such a process may be implemented using any appropriate combination of ultrasonic transducers, processors, and/or other structures as elaborated on further below.

It should be understood that any appropriate type of statistical model may be used with the various embodiments disclosed herein, including, but not limited to, a multivariant model, a neural network, a partial least squares regression model, a random forest regression model, a support vector machine regression, and/or any other appropriate type of statistical model of the solution including the particles suspended therein. In embodiments in which a multivariant model is used, a principal component analysis, partial least squares, orthogonal partial least squares, or other appropriate type of multivariant model may be used as the disclosure is not limited to the specific statistical model used with the embodiments disclosed herein.

It should be understood that the various embodiments described herein may be used to determine any appropriate combination of one or more properties of a plurality of particles suspended in a solution. These properties may include, but are not limited to, properties such as particle type, particle size (i.e. average maximum dimension of a particle), particle size distributions, concentrations of the particles, particle composition, particle stiffness, cell viability and/or any other appropriate parameter related to the particles suspended in the solution. In one embodiment, the property determined by a model may be a concentration of the particles in a solution. In another embodiment, the property may be a cell viability of cells suspended in the solution. In other embodiments, combinations of a concentration, cell viability, and/or any other appropriate parameter may be determined. In yet another embodiment, the particle composition may be determined. Depending on the applications this may also include determining the properties associated with mixtures including multiple populations of particles of different size and/or composition (i.e. determining properties for each particle population).

In another embodiment, a trained statistical model may be provided. For example, training data may be obtained for training the statistical model. The training data may include ultrasonic spectra. In some embodiments, the ultrasonic spectra may be substantially unprocessed, which may refer to the ultrasonic spectra, where were measured in the time domain, still being in the time domain without having been transformed to another domain, such as the frequency domain. The ultrasonic spectra may be measured for different particle suspensions where the one or more operating parameters to be measured may be varied between the different suspensions to provide a desired range of training data. The training data may also include corresponding particle suspension properties associated with each of the ultrasonic spectra. These properties may include, but are not limited to, properties such as particle type, particle size (i.e. average maximum dimension of a particle), particle size distributions, concentrations of the particles, particle composition, particle stiffness, cell viability, and/or any other appropriate parameter related to the particles suspended in the solution. Regardless of the specific training data, the training data may be used to generate a trained statistical model including. for example, a trained multivariant model by inputting the training data into an appropriate analysis module.

In order to provide the desired training data, ultrasonic spectra for different combinations of the desired one or more particle properties (e.g. particle type, size, concentration, etc.) may be conducted to obtain a desired number of training data points. Alternatively, in some embodiments, the training data may be obtained from data available from prior experiments and/or calculations. This training data may be input into a statistical model as elaborated on herein. Depending on the particular embodiment, the trained statistical model may be a multivariant model. In one such embodiment, the multivariant model may be a multivariant model of the particle suspension. However, regardless of the specific statistical model used, providing the training data to an appropriate statistical model analysis module may result in the desired trained statistical model being output. For example, once a trained statistical model has been generated, the trained statistical model may be stored for subsequent use. For instance, the trained statistical model may be stored on at least one non-transitory processor readable memory. The stored model may then be used for a number of different applications related to determining the properties of particles suspended within a solution as detailed further below.

The Inventors have recognized that large variations in concentration, or other particle properties, may affect the ability of a trained statistical model to accurately predict a desired property of a solution including a plurality of particles dispersed therein. More specifically, the Inventors have recognized that by determining an approximate concentration, or other property, of the particles within the solution, a more accurate trained statistical model associated with a range including the determined concentration, or other property, for the solution may be used. Thus, the determined property may be used to select one or more appropriate trained statistical models for subsequent use. This one or more second trained statistical models may provide an increased accuracy relative to the use of a single model. Additionally, while the embodiments described herein using two or more models determine a concentration first for selecting the appropriate second model, in other embodiments any appropriate particle property of the solution may be used to guide the selection of one or more other trained statistical models for subsequent use as the disclosure is not limited in this fashion.

In one embodiment, a method for characterizing a plurality of particles suspended in a solution may include obtaining an ultrasonic spectrum of the solution including the plurality of particles suspended therein. An ultrasonic spectrum of the solution including the plurality of particles suspended in the solution may be obtained either by measuring an ultrasonic signal emitted into the solution, or recalling a previously measured ultrasonic spectrum. Regardless, the ultrasonic spectra may be provided to a first trained statistical model that is configured to determine an estimate of a desired particle property, such as a concentration of the particles in the solution. For example, in some embodiments, the estimate of the desired particle property may include determining an approximate range of the particle property relative to a plurality of different ranges. In some embodiments, the determined estimate of the particle property may be used to select an appropriate second trained statistical model from a plurality of different trained statistical models associated with the different ranges of the particle property. The second trained statistical model may either be configured to more accurately determine the particle property and/or may be configured to determine a different particle property using the ultrasonic spectrum. For example a first trained statistical model may determine an approximate particle concentration which may then be used to select a second trained statistical model from multiple trained statistical models associated with different ranges of the concentration, or other property. This second trained statistical model may be configured to determine either a more accurate particle concentration and/or a different particle property such as particle size, cell viability, particle composition, and/or any other appropriate parameter disclosed herein.

The ultrasonic sensors and methods disclosed herein have multiple benefits relative to typical ultrasonic sensors used to characterize particles suspended in a solution. For example, in some embodiments, the systems and methods disclosed herein may be implemented without changing and/or interrupting a process. For instance, rather than stopping the agitation of a suspension to perform measurements on a quiescent solution, the currently disclosed systems and methods may be implemented to measure one or more particle properties of a solution during agitation of the solution. The currently disclosed systems and methods may also be more flexible, more accurate, faster, and easier to calibrate for changes in the particles being monitored. For example, in some embodiments, the use of measured ultrasonic spectra to determine the properties of a particle suspension may save on computational costs relative to systems and processes that may need to preprocess the spectra using one or more transformations and/or multiple analyzes to determine the desired properties. The use of the disclosed methods and system may thus result in faster computational times due to the reduced computational complexity. The disclosed systems and methods may also be relatively non-invasive on a solution being monitored, and in some embodiments, may be performed without the need for dyes, electrodes, special coatings, or other materials being introduced into or come into contact with the solution as may occur with other types of monitoring technologies.

In the various embodiments described herein obtaining an ultrasonic spectrum may refer to any appropriate method of obtaining an ultrasonic spectrum. For example, in one embodiment, this may include emitting an ultrasonic interrogation signal into a solution. An appropriate transducer, or other sensor, may then be used to sense the resulting ultrasonic spectrum which may then be transmitted to either a processor integrated with the system and/or a computing device remotely located from the system. Alternatively, in some embodiments, obtaining an ultrasonic spectrum may include recalling from non-transitory computer readable memory a previously recorded ultrasonic spectrum. Accordingly, it should be understood that any method for obtaining the ultrasonic signals used with any of the methods and/or systems described herein as the disclosure is not limited in this fashion.

Particles evaluated using the methods and systems disclosed herein may have any appropriate size range including sizes ranges (i.e. an average maximum transverse dimension) that are greater than or equal to 1 nm. 100 nm, 200 nm, 500 nm, 1 μm, 100 μm, 200 μm. 500 μm, and/or any other appropriate size range. Correspondingly, the size range may be less than or equal to 1000 μm, 500 μm, 200 μm, 100 μm, 500 nm, 200 nm, and/or any other appropriate size range. Combinations of the foregoing are contemplated including, for example, size ranges that are between or equal to 1 nm and 1000 μm, 500 nm and 500 μm, 500 nm and 100 μm, and/or any other appropriate size range as the disclosure is not limited in this fashion.

The solutions used with the systems and methods disclosed herein may exhibit any appropriate concentration range. For example, in some embodiments, a concentration range of particles in a solution may be greater than or equal to 10³, 10⁴, 10⁵, 10⁶, 10⁷, or 10⁸ particles per milliliter (mL). Correspondingly the concentration range of particles in the solution may be less than or equal to 10⁹, 10⁸, 10⁷, 10⁶, 10⁵, or 10⁴ particles per mL. Combinations of the foregoing are contemplated including, for example, concentrations in the range of 10⁴ to 10⁹ particles per mL though other concentrations are also contemplated.

The ultrasonic transducers disclosed herein may be operated using any appropriate frequency range for a desired application. That said, in some applications, a frequency range of an ultrasonic transducer used with the embodiments described herein may have an operating frequency that is greater than or equal to 1 MHZ, 5 MHZ, 10 MHZ, 15 MHz, 20 MHZ, and/or any other appropriate frequency range. The operating frequency may also be less than or equal to 30 MHZ, 25 MHZ, 20 MHZ, and/or any other appropriate frequency range. Combinations of the foregoing ranges are contemplated including an operating frequency of an ultrasonic transducer that is between or equal to 10 MHz and 30 MHz. Of course, systems that operate in frequency ranges both greater than and less than those noted above are also contemplated as the disclosure is not limited in this fashion.

Depending on the particular application the data input into a trained statistical model to determine the desired parameters of particles suspended in a solution may correspond to any appropriate inputs. That said, in one embodiment, an ultrasonic spectrum including data related to a measured signal amplitude versus time may be used. The trained statistical model may use the inputs to determine any appropriate parameters related to the plurality of particles. This may include parameters such as particle size and concentration in some embodiments. Further, in instances in which particles with different sizes are present in the same solution, the trained statistical model may be able to determine a concentration of each population of different sized particles. For example, in some embodiments, the disclosed methods and systems may be used for detecting the concentrations of cells suspended within a bioreactor. In one such embodiment, by measuring the relative concentrations of different size particles, it may be possible to determine a relative amount of healthy verses dead cells suspended in the solution. This may be done using a threshold size (i.e. a threshold maximum dimension) to differentiate between dead cells that have burst or otherwise changed size to be less than the threshold size and healthy cells that are above the threshold size. Of course, applications of size thresholds and/or the determination of particle sizes and concentrations for applications other than for a bioreactor also contemplated as the disclosure is not limited in this fashion. This may include, but is not limited to, the characterization of polymeric particles, metallic particles, ceramic particles, and/or any other particle that may be suspended within a desired solution.

While an embodiment using size thresholding is described above for determining a cell viability of cells included in a solution, in other embodiments a trained statistical model may be configured to determine the cell viability as previously described.

As noted above, the disclosed systems and methods may be used to characterize a number of different types of particle suspensions in a solution. Due to the impacts of various physical parameters of a particle suspension on a sensed signal, it may be desirable to calibrate a system for a number of different physical parameters that may be present during characterization of a solution including a plurality of suspended particles. This calibration may include either initial training of a statistical model using the physical parameters that may be present during operation and/or updating a model with additional training data. Parameters that may affect the sensed signals from a solution may include, but are not limited to, temperature, vessel thickness and/or geometry of a container containing a solution, solution composition, particle composition, particle size, particle concentration, and/or any other appropriate physical parameter and/or design feature associated with an ultrasonic sensor system.

In instances in which an ultrasonic sensor system includes a housing and/or other material that a transducer may transmit and/or receive an ultrasonic sensor through, it may be desirable for the housing, or other structural feature, to be made from a material with sufficient acoustic transparency to permit a signal with a desired signal strength to be transmitted and sensed through the material. This may include considerations such as selecting a material with relatively small acoustic losses in the desired operating frequency ranges as well as appropriately small thicknesses between the transducer and solution being characterized. Appropriate materials may include, but are not limited to, polymeric materials such as polycarbonate, polypropylene, polydimethylsiloxane (PDMS), polymethyl methacrylate (PMMA), glass, polyvinyl alcohol, polyvinyl acetate, polyethylene, and/or any other appropriate material as the disclosure is not limited to what materials a housing or other structure used to contain a solution is made from. Additionally, in instances where material is disposed between the transducer and the solution, the material may have a thickness that is between or equal to about 0.2 mm and 5 mm, and more preferably between or equal to about 1 mm and 3 mm, though thicknesses both greater than and less than these ranges are possible. In embodiments in which a housing or other structure with thicknesses greater than those noted above are used, the transducer may be received in a portion of the housing or other structure with a reduced thickness. For example, the transducer may be received in a blind hole sized and shaped to receive the transducer to place a transmitting end of the transducer in a desired position and orientation relative to an associated volume containing the solution. One such embodiment is elaborated on further below. In view of the above, it should be understood that the currently disclosed systems and methods should not be limited to any particular material and/or housing construction as the disclosure is not limited in this fashion. Additionally, in some embodiments, a separate housing may not be used. Instead, in such an embodiment, an ultrasonic transducer may be placed in contact with a container (such as a flexible bag or other container) that the solution is contained in without the use of a separate housing or structure associated with the ultrasonic sensing system. The ultrasonic transducer may then transmit an interrogation signal and sense the resulting ultrasonic spectrum through the container the solution is disposed in.

As used herein, an ultrasonic transducer may refer to an integrated transducer that is configured to both transmit an ultrasonic interrogation signal, i.e. a plurality of ultrasonic pulses with a desired waveform, as well as sense the resulting ultrasonic spectrum, including both reflected and backscattered ultrasonic signals, produced in response to the ultrasonic interrogation signal propagating through the physical structures of the system and the solution including the particles. Additionally, it should be understood that an ultrasonic transducer may refer to a system in which a separate ultrasonic transmitter and ultrasonic receiver are used to separately transmit the ultrasonic interrogation signal and sense the resulting ultrasonic spectrum respectively. Accordingly, it should be understood that the current disclosure is not limited to any specific construction of an ultrasonic transducer as the disclosure is not limited in this fashion.

For the sake of clarity, the majority of the embodiments described below in relation to the figures are directed to systems in which a solution including a plurality of particles suspended therein is disposed in an interior volume of a housing. For example, similar arrangements may be present in applications such as reactors including, but not limited to, bioreactors. However, the current disclosure should not be limited to only being used with systems in which a solution is disposed within an interior volume of a housing. In one such embodiment, an ultrasonic transducer is placed into acoustic contact with a bag including a solution disposed therein. Appropriate constraints to help ensure a repeatable arrangement of the ultrasonic transducer, relative spacing and arrangement of opposing sides of the bag, and/or other appropriate considerations for an ultrasonic measurement on a solution contained within a bag may be provided. Such a measurement system may be advantageous for use in applications where components are routinely reacted or grown in bags, including, but not limited to, cell culturing within bags. Accordingly, it should be understood that any appropriate construction capable of appropriately positioning and orienting a transducer towards a solution including a plurality of particles in a repeatable fashion for taking the desired ultrasonic measurements may be used as the disclosure is not limited to any particular physical construction.

In addition to the specific examples described below, it should be understood that the methods and systems disclosed herein may be used for any number of different applications including, but not limited to: non-invasive concentration measurements of nanoparticles, viruses, exosomes, and other particles; characterization of viruses inline with bioprocessing; characterization of exosomes; characterization of nanoparticles; characterization of particles during formulation and final drug product inspection; detection and/or characterization of bacterial and/or yeast contamination within a cell culture; detection and/or characterization of circulating tumors or different cell types for advanced therapies; and/or any other desired application where it may be desirable to detect the presence and/or characterize one or more properties of a plurality of particles suspended within a solution. Additionally, the methods and systems may either be provided as a standalone sensing system and/or they may be integrated into a system including a volume configured to contain a solution to be characterized. For instance, the disclosed sensing systems may be integrated a bioreactor. In another embodiment, a system may be configured to characterize volumes included in separate multiwell plates, tissue culture flasks, and/or other structures used to contain a solution. Accordingly, it should be understood that the disclosed methods and systems may be implemented in any number of different manners and should not be limited to just the currently disclosed embodiments.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

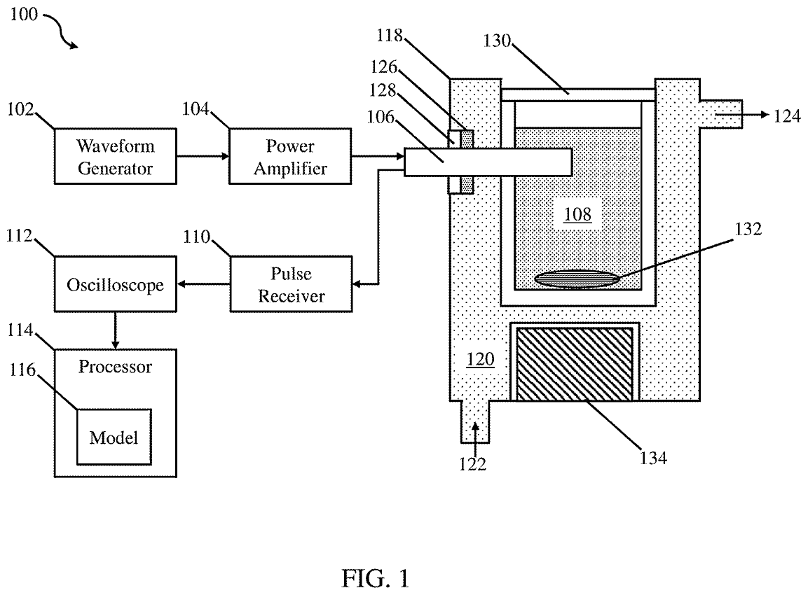

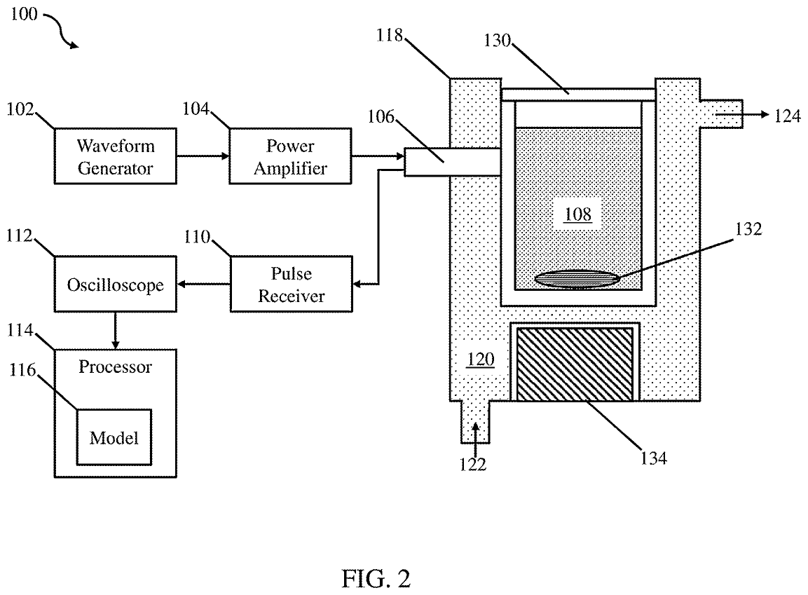

FIGS. 1 and 2 depict two similar embodiments of a sensor system 100. The depicted systems include a wave form generator 102 that may generate a desired ultrasonic waveform for transmission to an associated ultrasonic transducer 106 that is operatively coupled to the waveform generator. In some embodiments, an optional power amplifier 104, may be used to amplify a power of the waveform transmitted from the waveform generator to the ultrasonic transducer. In the depicted embodiment, the ultrasonic transducer is an ultrasonic transceiver that is configured to both transmit and sense ultrasonic signals. However, embodiments in which an ultrasonic transducer corresponding to a separate ultrasonic transmitter and corresponding ultrasonic receiver are used are also contemplated as the disclosure is not limited in this fashion. In either case, the sensed ultrasonic spectrum may be received by the pulse receiver 110. Depending on the particular implementation, the sensed ultrasonic spectrum may be output to an oscilloscope 112 which may then provide the ultrasonic spectrum to an operatively coupled processor 114. Alternatively, the measured ultrasonic signal may be provided directly to the processor depending on the particular application. In either case, the processor may be associated with non-transitory processor readable memory that includes an appropriate trained statistical model 116 stored thercon. The associated memory may also include processor executable instructions that when executed cause the processor to perform any of the methods disclosed herein.

While a processor associated with the oscilloscope has been illustrated in the figures, it should be understood that the depicted processor may be operatively coupled with any of the depicted components to generate the desired ultrasonic interrogation signal, sense the resulting ultrasonic spectrum, and perform the subsequent processing described herein as the disclosure is not so limited. Additionally, while a single processor has been depicted, it should be understood that any number of processors associated with any appropriate combination of the depicted components may be used. Further, these one or more processors may either be provided within a single integrated system and/or they may be provided separately as may be the case in which a separate attached or remotely located computing device including the processor is connected to the system.

The sensor system may also include a housing 118 that includes an internal volume configured to contain a solution 108 disposed therein. In some embodiments, the ultrasonic transducer 106 may extend into the solution as shown in FIG. 1. While the system shown in FIG. 1 is horizontal, embodiments in which a dipstick like configuration where the transducer is inserted into the solution in an at least partially vertical orientation relative to a local direction of gravity are also contemplated. In instances where the transducer extends through a wall of the housing, it may be desirable to provide a seal between the transducer and the housing. For example, as shown in FIG. 1, an O-ring 126 may be disposed in a counter bored hole 128 aligned with the through hole extending through the housing that the ultrasonic transducer is disposed in. Alternatively, embodiments in which an ultrasonic transducer does not extend into the solution are also possible. One such embodiment is shown in FIG. 2 where the ultrasonic transducer is disposed against a portion of the housing that is physically coupled with the solution disposed within the internal volume of the housing through a portion of the housing disposed between the transducer and solution. In the depicted embodiment, this corresponds to a blind hole oriented towards the solution that the transducer is disposed in such that the transducer is oriented towards the interior volume and solution contained therein, though other constructions may also be used. Regardless of the specific construction, the portion of the housing, or other structure, disposed between the transducer and solution may have a known thickness and material type such that the acoustic properties of the housing may be taken into account when transmitting and sensing ultrasonic signals. In either case, the transducer may be oriented towards the solution contained with the interior volume such that the transducer may transmit the desired ultrasonic waveforms into the solution and measure the resulting ultrasonic spectrum.

In some embodiments, it may be desirable to either agitate and/or seal a solution relative to an exterior environment during operation. For example, in some embodiments, a sensor system may be integrated into a bioreactor or other type of reactor where the solution may be agitated to help provide a uniform dispersion of nutrients, particles (e.g. cells), and/or other materials present within the solution during normal operation. Accordingly, in some embodiments, the system may include any appropriate type of mixer including the depicted stir bar 132 and corresponding stir bar actuator 134 disposed on an opposing side of an intervening portion of the housing. Other appropriate types of mixers may include, but are not limited to, a shaker table, actuated mechanical mixers immersed in the solution (magnet stirring rods, impellers, etc.), and/or any other appropriate type of mixer capable of agitating the solution within the housing as the disclosure is not so limited. In some embodiments, and as depicted in the figures, the interior volume corresponding to the depicted solution 108 disposed within the housing 118 may also be sealed from the exterior environment using a cover 130 and/or any other appropriate type of sealed construction as the disclosure is not limited to the particular type of housing and/or container that the sensor system is integrated in. However, embodiments in which the solution is not sealed relative to an exterior environment are also contemplated.

It may be desirable to control a temperature of a solution 108 either during operation and/or measurement of an ultrasonic signal. Accordingly, in some embodiments, a temperature regulation system such as the depicted water jacket 120 may be used. In the depicted embodiment shown in both FIGS. 1 and 2, the water jacket includes an inlet 122 that a liquid, such as water, flows into prior to flowing around the internal volume contained within the housing 118 to a corresponding outlet 124. As the liquid flows through the water jacket, heat may be exchanged with the solution contained within the internal volume of the housing to either heat or cool the solution depending on the specific application. It should be understood that other appropriate methods of controlling the temperature of a solution may also be used including, but not limited to, immersion heaters, immersion coolers, actively controlled coolers and/or heaters integrated within the housing (e.g. resistive heaters, thermoelectric materials, etc.), and/or any other appropriate type of temperature control may be used.

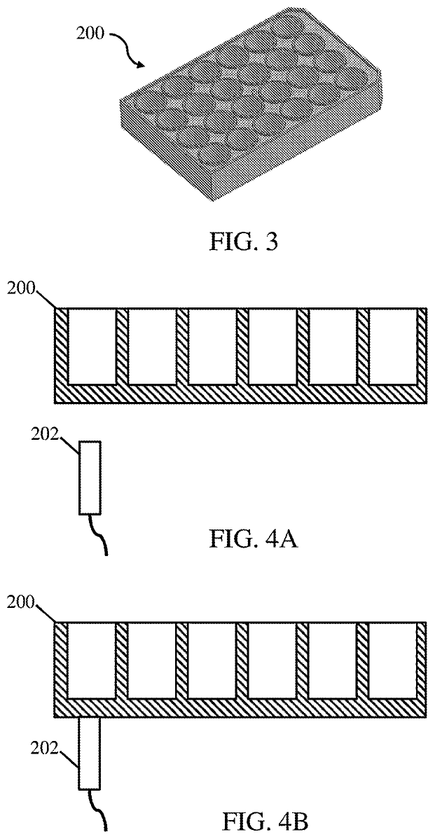

While FIGS. 1 and 2 depict the use of a sensor system with a single volume contained within the housing, it should be understood that the current disclosure is not limited to implementations with a single volume of a solution. For example, FIG. 3 depicts one embodiment of a well array plate 200 such as may be used in a cell culture plate or other appropriate application. In many instances, it may be desirable to measure the parameters associated with the particles (e.g. cells) contained within the individual wells of the depicted well array. Accordingly, in some embodiments, one or more ultrasonic transducers 202 may either be moved into contact, and/or may be integrated with, the individual portions of the plate associated with the separate wells of the well array plate 200, see FIGS. 4A and 4B. This may allow the individual interrogation of the solutions contained in the different wells using the ultrasonic transducer. The portions of the well plate that the ultrasonic transducer is placed into contact with may be made from an appropriate material and may have a desired predetermined thickness suitable for conducting the types of measurements described herein. In instances where either a single ultrasonic transducer, or multiple transducers that are less than a total number of wells and the plate, are used, either the well plate and/or the one or more ultrasonic transducers may be associated with an appropriate movement stage or robotic arm for moving into and out of contact with one another to permit the different wells of the plate to be measured sequentially, see FIGS. 4A and 4B. In other instances, an equal number of ultrasonic transducers and wells may be used to permit the simultaneous measurement of the different wells.

In view of the above, it should be understood that the currently disclosed systems and methods may be incorporated into any appropriate system where it is desirable to measure the properties associated with a plurality of particles suspended in a solution.

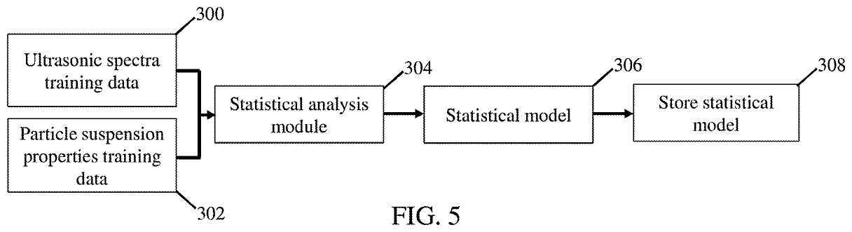

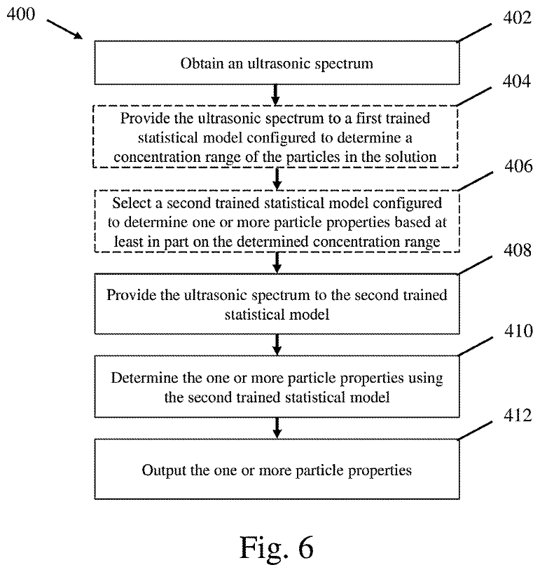

FIGS. 5 and 6 depict embodiments related to methods for training and using statistical models for use with the disclosed ultrasonic systems.

In the embodiment illustrated in FIG. 5, training data may be input into an analysis module, such as the depicted multivariant analysis module 304. In some embodiments, the training data may correspond to measured ultrasonic spectra training data 300 as disclosed herein. For example, in one embodiment, the ultrasonic spectra may correspond to unprocessed ultrasonic spectra that are in the original time domain they were measured in. The measured spectra may include a single ultrasonic interrogation signal and corresponding response signal. The response signal may include both reflected and backscattered ultrasonic signals including a wall response signal corresponding to the interrogation signal contacting an opposing surface of a volume containing the solution being measured. However, instances in which ultrasonic spectra including multiple interrogation and response signals are used are also contemplated. The training data may also include one or more corresponding measured particle properties 302 (e.g. particle type, size, concentration, etc.) associated with each of the ultrasonic spectra. After the training data is fed into the multivariant analysis module, or other appropriate training module, a trained statistical model, such as a trained multivariant model, may be output from the analysis module at 306. The multivariant model may then be stored in an appropriate non-transitory processor readable memory for subsequent recall and/or use. Depending on the particular application, the processor and associated memory used to capture and analyze the ultrasonic spectra may be integrated into a single system. However, embodiments in which sensing and analysis modules are implemented on separate systems using separate processors are also contemplated.

The above noted training data may be obtained in any appropriate fashion using experiments and/or calculations. Due to the difficulty in experimentally determining this training data, the training data may be limited to a predetermined number of data points. Depending on the expected variations and complexity associated with a particle suspension to be measured, either a larger or smaller number of data points may be needed to train the desired statistical model. For example, the number of training data points may be greater than or equal to 20 data points, 50 data points, 100 data points, 500 data points, or other appropriate number of data points. Correspondingly, the number of training data points may be less than or equal to 2000 data points, 1000 data points, 500 data points, and/or any other appropriate number of data points. Combinations of the foregoing are contemplated including, a number of training data points that is between or equal to 20 data points and 100 data points, 20 data points and 2000 data points, and/or any other number of data points both greater than and less than the ranges noted above as the disclosure is not so limited. Regardless of the specific number, these training data points may be randomly selected throughout the desired range space of particle properties, evenly distributed throughout the range space, and/or any other appropriate disposition as the disclosure is not limited in this fashion.

FIG. 6 depicts one embodiment of a method 400 of using a trained statistical model to identify one or more properties associated with a plurality of particles suspended within a solution. The illustrated sensing and analysis functionalities may be implemented using any appropriate configuration of one or more processors as described previously above. In the depicted embodiment, an ultrasonic spectrum may be obtained. For instance, the ultrasonic spectrum may be measured for a solution including a plurality of particles suspended therein using any appropriate system including, for example, the systems described above, see 402. As noted previously, in some embodiments, the ultrasonic spectra may be substantially unprocessed. At 404, the ultrasonic spectrum may optionally be provided as an input to a first trained statistical model that has been calibrated for a particular sensor system and type of solution using training data as detailed above. The first trained statistical model may determine and output an estimate of a first particle property, such as a concentration of the particles, using the ultrasonic spectrum. The determined first particle property may then be used to select a second trained statistical model at 406 based at least in part on the determined first particle property. In some instances, the second trained statistical model may be selected from a plurality of trained statistical models associated with different ranges of the estimated particle property where the selected second trained statistical model is associated with a range including the determined estimate of the particle property.

Regardless of whether or not a first trained statistical model is used to select a second trained statistical model, the ultrasonic spectrum may be provided as an input to the second trained statistical model at 408. The second trained statistical model may be configured to determine one or more particle properties using the input ultrasonic spectrum where the one or more particle properties may either be the same, or different than, the first particle property estimated by the first trained statistical model at 410. In some embodiments, the first and second trained statistical models may be trained multivariant models. The trained statistical model may output at least one, and in some instances, multiple particle properties associated with the plurality of particles suspended within the solution at 412. For instance, the one or more determined properties associated with the plurality of particles may either be displayed to a user using any appropriate type of display and/or stored in an associated non-transitory processor readable memory for subsequent recall and/or usage (e.g., locally and/or remotely).

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, a tablet computer, or processors integrated with an overall system. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a processor readable storage memory (or multiple processor readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more processors, perform methods that implement the various embodiments discussed above. As is apparent from the foregoing examples, a processor readable storage memory may retain information for a sufficient time to provide processor-executable instructions in a non-transitory form. Such a processor readable storage medium or media can be transportable, such that the program or programs stored thereon can be loaded onto one or more different processors to implement various aspects of the present disclosure as discussed above. As used herein, the term “processor-readable storage memory or medium” encompasses only a non-transitory processor-readable medium that can be considered to be a manufacture (i.e., article of manufacture) or a machine. Alternatively or additionally, the disclosure may be embodied as a processor readable medium other than a processor-readable storage medium, such as a propagating signal.

The terms “program” or “software” are used herein in a generic sense to refer to any type of computer code or set of processor-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

### Example: Measurement Methods

A 25 mm polyoxymethylene cube with a 10 mm vertical drill out and a 4 mm horizontal hole centered on the same plane was prepared. An ultrasonic transducer was positioned in the horizontal hole. The horizontal hole for the transducer was counterbored on the external face to accept an O-ring to seal the internal volume that the transducer was disposed within. Thin acrylic plates were used to seal the bottom and sides of the system.

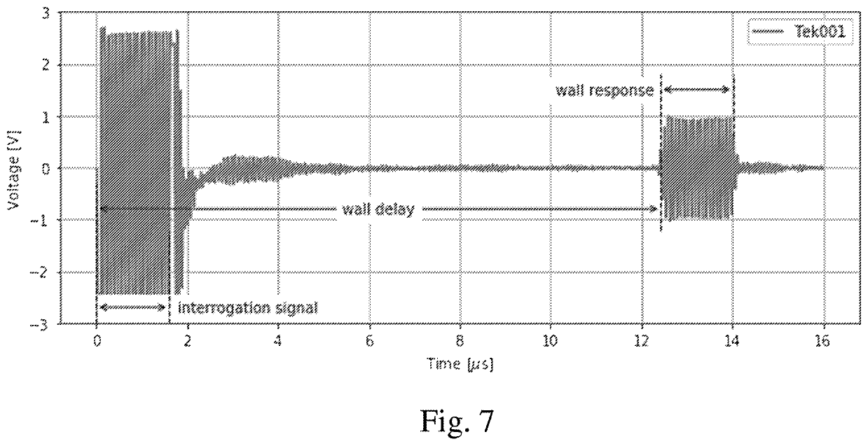

Solutions including known particles with known particular sizes and different particle concentrations were prepared as detailed further below. Ultrasonic measurements were then conducted for different stir rates for concentration measurements and under quiescent conditions (i.e. no stirring) for size measurements. During measurements, the ultrasonic transducer was driven using a peak to peak voltage of 3 V for 420 cycles at 12.5 MHz with a pulse duration of 80 ns and a burst duration of 16 μs. A 40 dB gain was used during measurements. The signal was digitized using a 40 ms capture duration with a sampling rate of 125 MSa/s for a total of about 5 MSa (2500 bursts). An exemplary ultrasonic burst is shown in FIG. 7. The illustrated signal includes the interrogation signal and the subsequent wall response after the associated wall delay. The wall response corresponds to the reflection of the signal from an opposing wall located on an opposite side of the volume containing the solution relative to a position of the transducer. As seen in the figure, a strong wall response was evident in the current experimental setup. The signal between the interrogation signal and the wall response corresponds to the portion of the ultrasonic spectrum provided by particle backscatter of the interrogation signal.

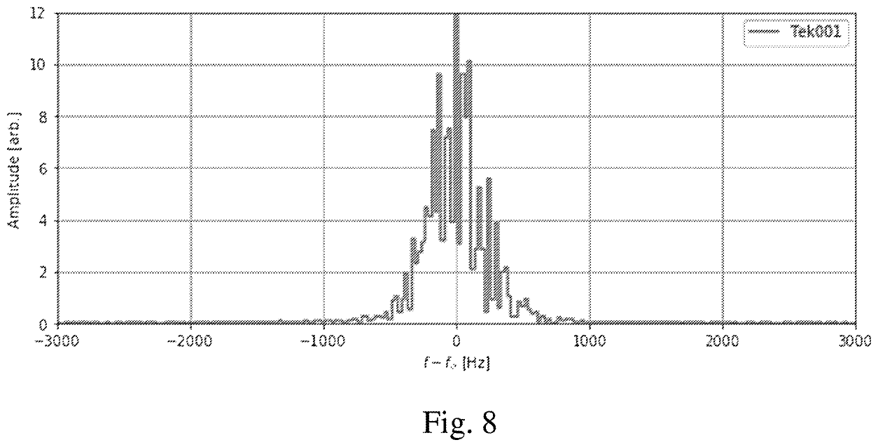

FIG. 8 illustrates a Fast Fourier Transform of a full 40 ms ultrasonic signal collected at the highest concentration, centered on 12.5 MHz. Bin widths of 25 Hz were used to determine the counts at each frequency range. At 25 Hz/bin and about 120 bins total to either side, the window in the depicted plot is about 3000 Hz wide on either side of center. However, no discernible peaks were present beyond about +1000 Hz to either side of center.

### Example: Polymer Particle Characterization

Water suspensions including polystyrene latex particles were prepared. The polystyrene latex particles were obtained in sizes ranging from 50 nm up to 11 μm in diameter. Solutions with concentrations ranging from about 10⁴ to 10¹¹ particles/ml were prepared for testing. Ultrasonic signals were generated, received, and processed using the configuration and equipment detailed above with the modification of a peak to peak voltage of 10 V and a burst period of 6 μs. While it is expected that the resulting signals may vary based on the specific waveforms and transducer frequencies used, the current systems and methods may use any appropriate combination of waveforms and signal processing as the disclosure is not limited in this fashion. Data received from the oscilloscope was formatted and organized to be compatible with SIMCA multivariant data analysis software which was used to analyze the measured training data to provide a trained multivariant model for subsequent use.

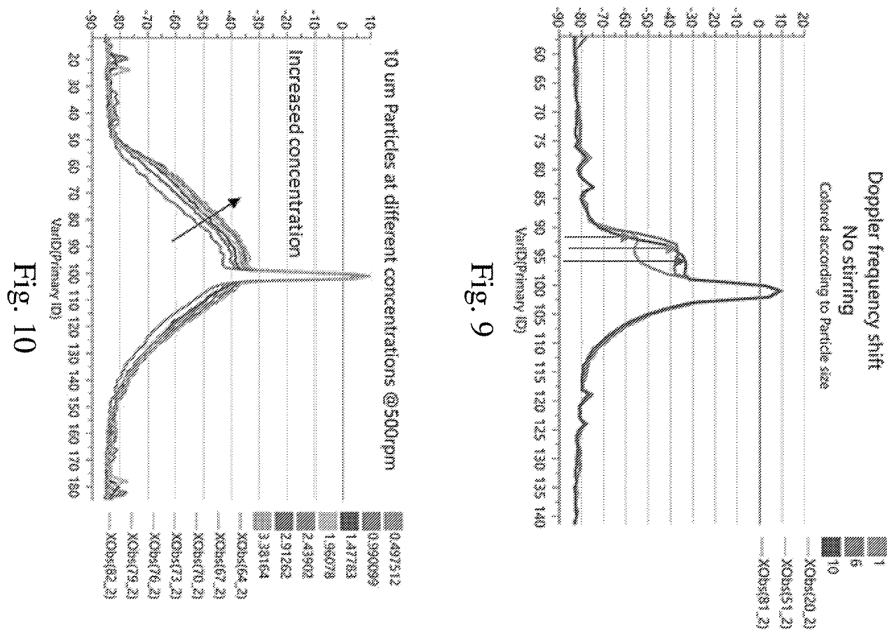

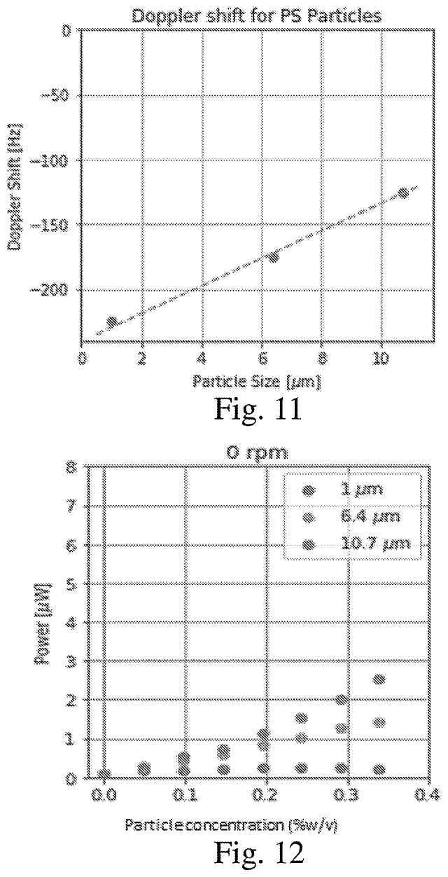

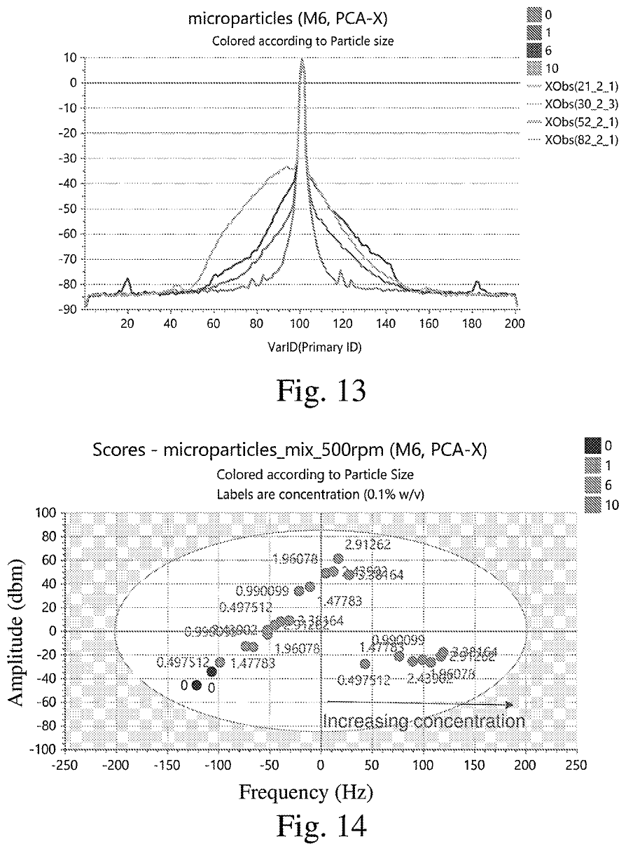

FIG. 9 is a graph of one example of a Fast Fourier Transform of ultrasonic signals that were captured for solutions including polystyrene latex particles with sizes of ranging between 1 μm and 10 μm at concentrations ranging between 0.05 w/v % to 0.34 w/v % where the weight/volume percentage may be measured in units grams or particles per 100 mL. The signals were obtained without stirring the solution so that the measurements were performed on a quiescent solution. The Doppler shift associated with the different size particles is indicated by the arrows in the graph. FIG. 10 is a graph of a Fast Fourier Transform of ultrasonic signals captured for solutions including 10 μm polystyrene latex particles in various concentrations ranging between about 0.5 w/v % and 3.4 w/v %. The measurements were obtained during stirring of the solution at 500 rpm. This figure illustrates how the peak associated with the Doppler frequency shift is obscured and broadened due to movement of the particles within the solution. Additionally, the area under the curve for the different transformed ultrasonic spectra generally increases with increasing concentration as shown in the figure. The observed increase in Doppler shift for the measured particles as well as the increasing area, or power, under the curve with increasing particle concentration are illustrated in the graphs depicted in FIGS. 11 and 12 for particles with average sizes of 1 μm, 6.4 μm, and 10.7. FIG. 13 presents another series of tests for different size particles suspended in water with a concentration of 0.34% wt/v during stirring at 500 rpm. Similar to the above, a Fast Fourier Transform of the measured ultrasonic signals was applied to the sensed measurements. As shown in the figure a larger overall amplitude in the transformed signal is observed for all particle solutions relative to the control that included no particles (0 μm size) and the 10 μm particles exhibited the largest amplitude in the transformed signal.

As illustrated by the above graphs, the interaction of particle size and concentration versus the observed signals is not straight forward, and the Doppler frequency shift becomes obscured when measurements are performed on solutions during mixing. Accordingly, it may not be possible to both accurately and easily identify one or more desired properties of a particle suspension including, for example, the particle size and/or particle concentrations shown in these examples. That said, as elaborated on in the above disclosure, a multivariant model, or other appropriate trained statistical model, may be used to identify appropriate relationships from the measured training data to both accurately and easily predict the properties of a particle suspension based on the sensed ultrasonic spectra. Accordingly, the raw unprocessed ultrasonic spectra were used to train a statistical model to predict the desired properties of the particle suspension without the need for any preprocessing. However, instances in which the signals may be preprocessed in some manner are also contemplated as the disclosure is not limited in this fashion. An example of a trained multivariant model obtained using an orthogonal partial least squares fit is shown in FIG. 14. As shown in the graph, the model was trained with different sized particles ranging from a control with no particles up to particles with sizes of about 10 μm. The different particle sizes are clustered together in different portions of the graph with increasing concentrations being observed with the different spectra clusters being located further to the right in the graph. Good agreement was obtained using the trained statistical model and verification data.

### Example: Chinese Hamster Ovary (CHO) Cells

Chinese hamster ovary (CHO cells) were obtained and incubated until the desired cell concentrations were achieved for testing. The incubated CHO cells were pipetted into 250 ml vessels and placed in a Bioreactor. The bioreactor was operated for 2-3 days without nutrient growth media being added and only standard controls being monitored, e.g. pH, temperature, aspirated oxygen, while stirring the solutions at various stir rates. The resulting solutions with different concentrations and about 95% cell viability were then tested using the above noted testing procedure.

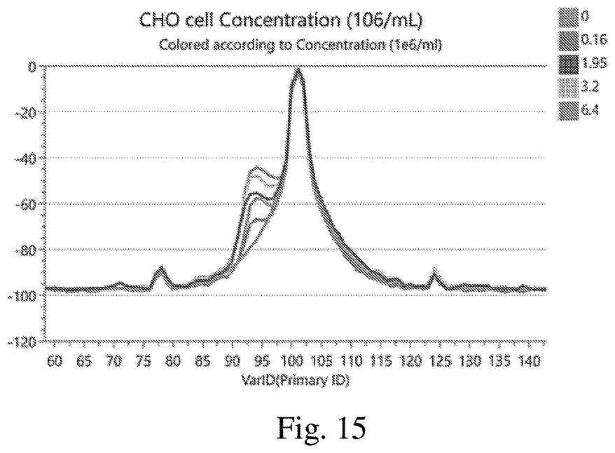

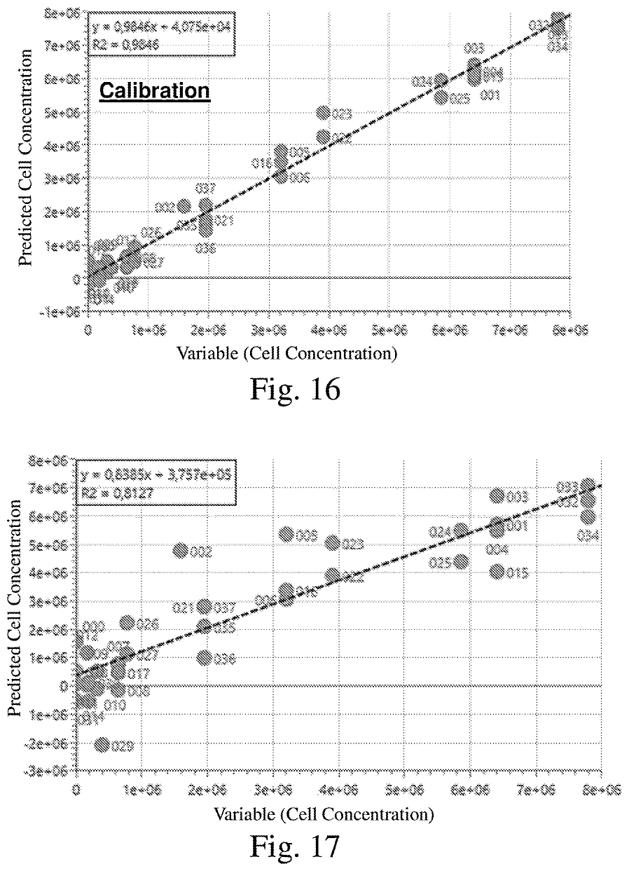

FIG. 15 presents a graph of transformed ultrasonic spectra for CHO cells at different concentrations ranging between a control with no cells present in the solution to a solution including 6.4×10⁶ cells/ml. The spectra were obtained without stirring. As expected, the Doppler shift peak to the left of the primary peak increases with increasing cell concentration. FIG. 16 illustrates a calibration curve from a multivariant model and the associated training data for predicting the cell concentration using the measured ultrasonic spectra. The multivariant model used in the depicted graph was trained using a partial least squares regression method. Cross validation data from ultrasonic signals that were not included in the training data are presented in FIG. 17 where good agreement between the predicted and measured cell concentrations was observed.

### Example: Realtime Monitoring within a Reactor

An ultrasound transducer was mounted on an exterior surface of a 250 mL Sartorius AMBR® bioreactor from with glycerin used as an acoustic coupling media disposed between the ultrasonic transducer and the exterior surface of the bioreactor. The frequency, burst cycles, and burst frequency were controlled via a function generator and the resulting measured response signal was amplified and monitored via an oscilloscope.

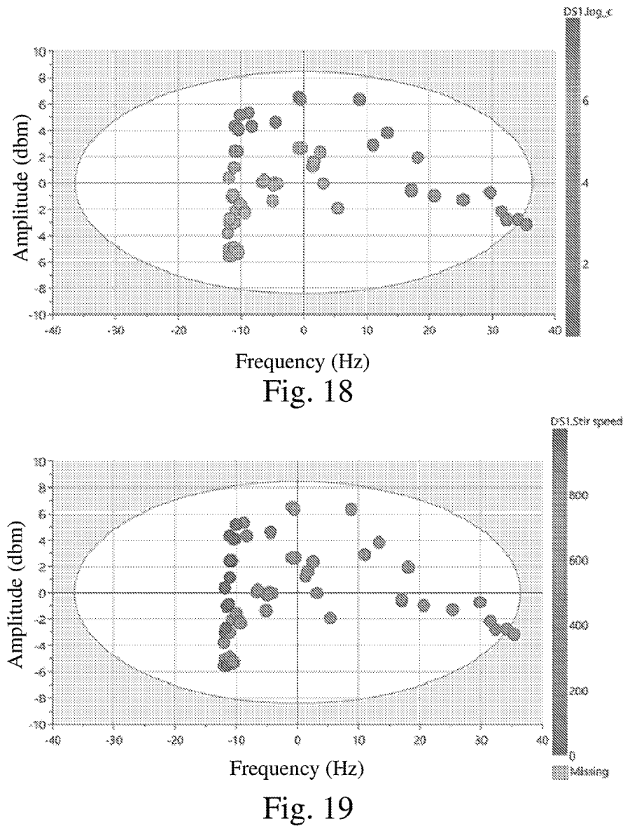

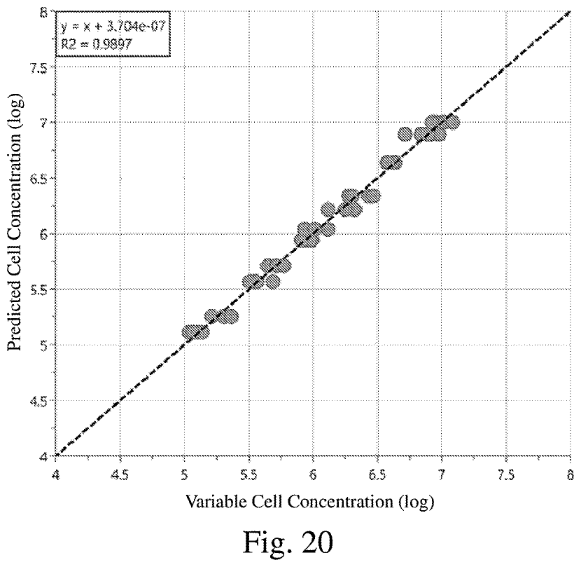

Chinese hamster ovary (CHO) cells with 95% viability were put in the bioreactor at various concentrations (13.7×10⁶ cell/ml, 22.3×10⁶ cell/ml, 33.7×10⁶ cell/ml, 44×10⁶ cell/ml, and 54×10⁶ cell/ml). The temperature was held at 36.8° C. The stir rate was varied from 0 to 860 revolutions per minute (rpm) (nominally 0, 285, 570, and 855 rpm). The transducer had a center frequency of 15 MHz and a focal length of 6 mm. Backscattered sound was Fourier Transformed, and the resulting spectra were averaged 256 times. The averaged spectrum, with a 10 kHz window around the transducer center frequency, was stored for later processing. The training spectra were fed into SIMCA® software for multivariant data analysis. The software trainer used a Partial least squares regression (PLS) model to the training data. The R2 was 0.9897 and Q was 0.895 demonstrating that the model can accurately predict the concentration of CHO cells. FIG. 18 is a plot of the measured amplitude and frequency for different concentrations. FIG. 19 is a plot of the measured amplitude and frequency for different stirring speeds. FIG. 20 is a plot of the predicted versus actual CHO cell concentrations using the trained model.

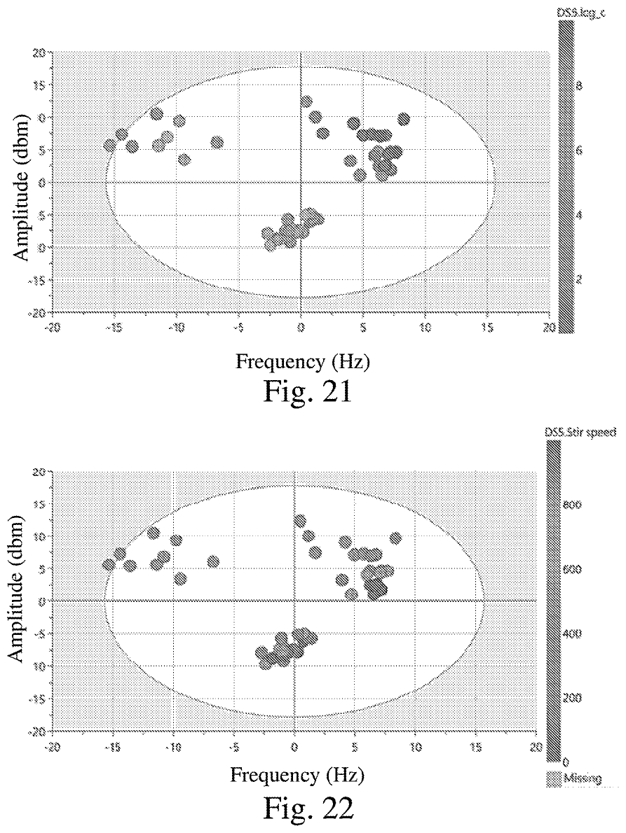

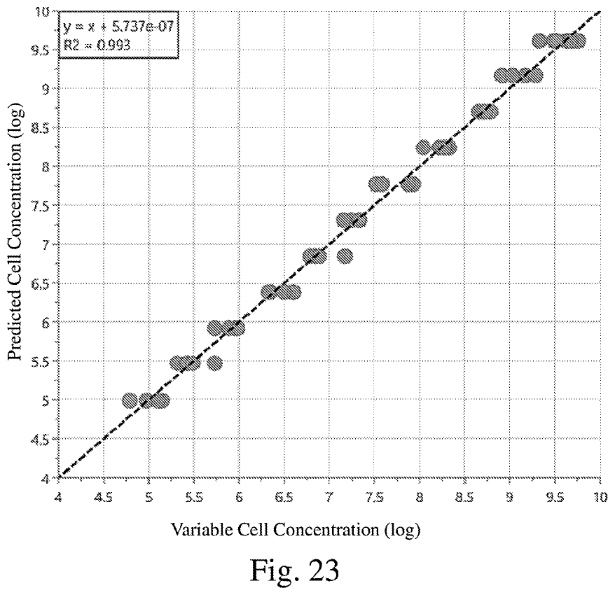

Using a similar experimental setup as described above, 200 nm polystyrene nanoparticles were placed in the bioreactor at various stir rates and concentrations. The temperature was held at 36.8° C. The concentration of nanoparticles during testing included 0 to 0.0995, 0.29, 0.84, 2.44, 7.07, 20.5, 59.5, 172, 499, 1450, and 4080 million particles per milliliter. The stir rate was varied from 0 to 855 revolutions per minute (rpm) (nominally 0, 285, 570, 855) for each concentration sample. The spectra were then averaged and fed into the SIMCA® software and a PLS model was fit to the data as detailed above. The R2 value was 0.993 and the Q value was 0.81 demonstrating a good predictable fit to characterize the concentration of the nanoparticles within the bioreactor was obtained. FIG. 21 is a plot of the measured amplitude and frequency for different concentrations. FIG. 22 is a plot of the measured amplitude and frequency for different stirring speeds. FIG. 23 is a plot of the predicted versus actual nanoparticle concentrations using the trained model.

### Example: CHO Variable Cell Concentration

Several CHO cell suspension solutions were prepared at concentrations ranging from 1.65×10⁵ cells/mL to 1.0×10⁸ cells/mL within CHO cell culture media. The samples were then placed in bioreactor vessels (Ambr 15). The cells exhibited a high viability around 99%. The stir rate was kept constant as 955 rpm for all the samples and the temperature was kept at 37.0° ° C. The cell concentration was measured using a CEDEX cell counter separately as a reference to calibrate the model.

Using a two step multivariate data analysis model, the cell concentration was predicted over a wide range by first classifying the samples into 3 groups of low (less than 3×10⁶ cells/mL), medium (3 to 15×10⁶ cells/mL), and high cell concentration (greater than 15×10⁶ cells/mL) using an orthogonal projections to latent structures discriminant analysis (OPLS-DA). Separate models associated with the different concentration ranges were selectively used based on the first concentration prediction. The second models were orthogonal projections to latent structures (OPLS) models that were trained over the corresponding concentrations ranges.

The first step of approximating the cell concentrations into low, medium, and high cell concentrations exhibited a 100% accuracy in sorting both the training and testing data into the appropriate concentration range. For validation samples of the low concentration class, Root Mean Square Error of Predictions (RMSEP) was reduced from 1.26E+07 to 1.02E+05 (99.19% reduction) in favor of the two-step modeling approach. In a similar manner, RMSEP values for the medium, and high concentration classes were reduced by 98.67% and 32.18% respectively. Accordingly, the two step analysis shows a significant improvement in accuracy as compared to the use of a single trained statistical model using the same data.

### Example: CHO Cell Viability Measurements

A trained statistical model was demonstrated to be capable of predicting cell viability within a range between about 3% and 99%. First, samples were prepared with different cell viability ratios. Specifically, CHO cell suspension in a shake flask was allowed to grow to a concentration of more than 6×10⁶ cells/mL and then the flask cap was wrapped with parafilm to prevent air flow into the flask. Consequently, the cells started to die and reached a viability of almost zero within 3 to 4 days. The dead cell population was then mixed with a high viability population to make samples with variable viabilities. The cell viabilities in the different source solutions were measured using an optical cell counter. The resulting cell viabilities in the different samples was calculated from the known cell viabilities and volumes used from the source solutions. Ultrasonic spectra were then recorded using the methods detailed above.

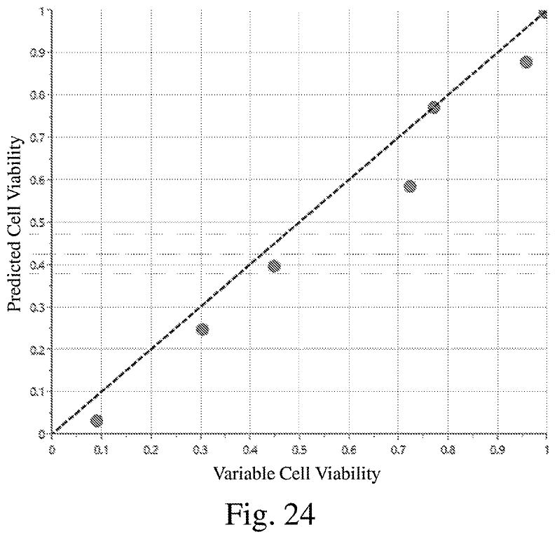

The recorded ultrasonic spectra and cell viability data were used as training and testing data for a trained statistical model. Specifically, similar to the above example regarding concentration, the samples were sorted into low, medium, and high concentration samples using an OPLS-DA model prior to a selecting and using a corresponding OPLS model associated with the concentration range of the sample. The second OPLS model was trained to predict the cell viability with a high accuracy. FIG. 24, shows the prediction capability of a trained PLS model. The data presented in the graph were not seen by the model and were kept out of the training dataset.

### Example: Particle Characterization

Solutions of nanoparticles of different material compositions were tested in a bioreactor (Ambr 15) in concentrations ranging from 10⁹ to 10¹² particles/mL. The stir rate was kept at 955 rpm and the temperature was set to 24° C. The solutions included water (i.e., no particles) as well as particles corresponding to: flurosphere (200 nm); silica mesoporous (200 nm); silica non-porous (200 nm); and titania (300 nm). An OPLS-DA models was used to predict which material the nanoparticles suspended in solution were and the concentration of the particles (e.g., low, medium, high, etc.). The verification dataset exhibited a 100% accuracy for predicting the composition of the particles.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method for characterizing a plurality of particles suspended in a solution, the method comprising:
obtaining an ultrasonic spectrum of the solution including the plurality of particles suspended in the solution; providing the ultrasonic spectrum to a trained statistical model of the solution; and
determining one or more properties of the particles using the trained statistical model.

2. (canceled)

3. The method of claim 1, wherein obtaining the ultrasonic spectrum includes:
emitting an ultrasonic interrogation signal into the solution including the plurality of particles suspended in the solution; and
sensing the resulting ultrasonic spectrum.

4. The method of claim 1, wherein the trained statistical model is a trained multivariant model.

5. (canceled)

6. The method of claim 1, further comprising agitating the solution during sensing.

7. The method of claim 1, wherein the ultrasonic spectrum is an unprocessed ultrasonic spectrum.

8. The method of claim 1, wherein the one or more properties include at least one selected from the group of a particle type, particle size, particle size distribution, concentration, composition, stiffness, and cell viability.

9. The method of claim 1, wherein the plurality of particles are a plurality of cells suspended in the solution.

10. The method of claim 9, further comprising determining a viability of the plurality of cells based on the one or more determined properties.

11. (canceled)

12. An ultrasonic sensor system comprising:
an ultrasonic transducer configured to emit an ultrasonic interrogation signal into a solution including a plurality of particles suspended in the solution, wherein the ultrasonic transducer is configured to sense a resulting ultrasonic spectrum; and
a processor operatively coupled to the ultrasonic transducer, wherein the processor is configured to receive the ultrasonic spectrum from the ultrasonic transducer, and wherein the processor is configured to perform the steps of:
providing the ultrasonic spectrum to a trained statistical model of the solution; and
determining one or more properties of the particles using the trained statistical model.

13. The ultrasonic sensor system of claim 12, wherein the trained statistical model is a trained multivariant model.

14. (canceled)

15. The ultrasonic sensor system of claim 12, further comprising a mixer configured to agitate the solution during operation of the ultrasonic sensor system, a volume configured to contain the solution, and/or a housing.

16. The ultrasonic sensor system of claim 12, wherein the ultrasonic spectrum is an unprocessed ultrasonic spectrum.

17. The ultrasonic sensor system of claim 12, wherein the one or more properties include at least one selected from the group of a particle type, particle size, particle size distribution, concentration, composition, stiffness, and cell viability.

18. The ultrasonic sensor system of claim 12, wherein the plurality of particles are a plurality of cells suspended in the solution.

19. The ultrasonic sensor system of claim 18, wherein the processor is configured to perform the step of determining a viability of the plurality of cells based on the one or more determined properties.

20-22. (canceled)

23. The ultrasonic sensor system of claim 15, further comprising the volume configured to contain the solution and further comprising the solution contained in the volume.

24. A method for training a statistical model, the method comprising:
obtaining training data, wherein the training data includes ultrasonic spectra for solutions including particles suspended in the solutions and one or more properties of the particles associated with the ultrasonic spectra;
generating a trained statistical model using the training data; and
storing the trained statistical model for subsequent use.

25. The method of claim 24, wherein the trained statistical model is a trained multivariant model.

26. The method of claim 24, wherein the one or more properties include at least one selected from the group of a particle type, particle size, particle size distribution, concentration, composition, stiffness, and cell viability.

27. The method of claim 24, wherein the ultrasonic spectra are unprocessed ultrasonic spectra.

28. A method for characterizing a plurality of particles suspended in a solution, the method comprising:
obtaining an ultrasonic spectrum of the solution including the plurality of particles suspended in the solution;
providing the ultrasonic spectrum to a first trained statistical model;
determining a first property of the plurality of particles in the solution using the first trained statistical model;
selecting a second trained statistical model based at least in part on the first property;
providing the ultrasonic spectrum to the second trained statistical model; and
determining a second property of the plurality of particles using the second trained statistical model.

29. (canceled)

30. The method of claim 28, wherein the first property is a concentration of the plurality of particles.

31. The method of claim 28, wherein the second property is at least one selected from a particle type, particle size, particle size distribution, concentration, composition, stiffness, and cell viability.

32. The method of claim 28, wherein the first property is different than the second property.

33. The method of claim 28, wherein the first property is the same as the second property.

34. The method of claim 28, wherein obtaining the ultrasonic spectrum includes:
emitting an ultrasonic interrogation signal into the solution including the plurality of particles suspended in the solution; and
sensing the resulting ultrasonic spectrum.

35. The method of claim 28, wherein the first trained statistical model and the second trained statistical model are trained multivariant models.

36. The method of claim 28, wherein the ultrasonic spectrum is an unprocessed ultrasonic spectrum.

37. The method of claim 28, wherein the plurality of particles is a plurality of cells suspended in the solution.

38. (canceled)

39. The method of claim 28, further comprising agitating the solution during sensing.

40. (canceled)

41. An ultrasonic sensor system comprising:
an ultrasonic transducer configured to emit an ultrasonic interrogation signal into a solution including a plurality of particles suspended in the solution, wherein the ultrasonic transducer is configured to sense a resulting ultrasonic spectrum; and
a processor operatively coupled to the ultrasonic transducer, wherein the processor is configured to receive the ultrasonic spectrum from the ultrasonic transducer, and wherein the processor is configured to perform the steps of:
providing the ultrasonic spectrum to a first trained statistical model;
determining a first property of the plurality of particles in the solution using the first trained statistical model;
selecting a second trained statistical model based at least in part on the first property;
providing the ultrasonic spectrum to the second trained statistical model; and
determining a second property of the plurality of particles using the second trained statistical model.

42. (canceled)

43. The ultrasonic sensor system of claim 41, wherein the first property is a concentration of the plurality of particles.

44-55. (canceled)
